(19) United States
(12) Patent Application Publication
(10) Pub. No.: US 2008/0201379 A1
(43) Pub. Date: Aug. 21, 2008

(54) Method and apparatus for generating digest of captured images

(75) Inventor: Shin Nakate, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 12/071,147

(22) Filed: Feb. 15, 2008

(30) Foreign Application Priority Data
Feb. 19, 2007 (JP) 2007-037323
Jan. 23, 2008 (JP) 2008-012411

(51) Int. Cl. G06F 17/00

(52) U.S. Cl. 707/104.1; 707/E17.019

(57) ABSTRACT

A tag is generated for each of moving-image files. The tag includes genre information and event identification information. The genre information represents a genre of an event relating to the moving-image file. The event identification information identifies the event relating to the moving-image file. The moving-image files are classified into groups corresponding to respective events in response to the event identification information in the tags. Time intervals in shooting between the moving-image files are detected. Moving-image files in each of the event corresponding groups are classified into groups corresponding to respective scenes in response to the detected time intervals. Portions are extracted from moving-image files in each of the scene corresponding groups in response to the genre information in the tags. Data representative of a digest is generated from the extracted portions.

### BACKGROUND OF THE INVENTION

1. Field of the Invention

This invention relates to a method and an apparatus for generating data representing a digest of a moving-image file or files made through the use of a moving-image camera such as a video camera, a digital camera, and a camera portion of a mobile telephone set.

2. Description of the Related Art

Japanese patent application publication number 2004-295231 discloses a method utilizing an index file indicating the photographing dates of respective image frames, that is, the dates when respective image frames were taken. In the method of Japanese application 2004-295231, the image frames are separated into a plurality of groups according to the intervals between the photographing dates indicated by the index file. A representative image is decided within each group. An image data file indicating the representative images is generated.

In the method of Japanese application 2004-295231, the grouping of the image frames depends on the photographing dates rather than the contents or genres of the image frames. Thus, the method of Japanese application 2004-295231 can not decide a representative image suited to each genre.

Generally, a suitable representative portion or a suitable feature portion of a moving-image file tends to vary from genre to genre of the contents of the file.

Japanese patent application publication number 2001-186476 discloses a method using an electronic camera to generate image files. In the method of Japanese application 2001-186476, the generated image files are assigned photographing time ranges or photographing places, respectively. The image files are automatically divided into groups according to photographing time range or photographing place.

U.S. Pat. No. 6,160,950 corresponding to Japanese patent application publication number 10-032776 discloses a method having a step of deciding whether or not a sound signal in a composite video sound signal is in a prescribed condition, a step of detecting a portion of the composite video sound signal which corresponds to the sound signal being in the prescribed condition, and a step of labeling the detected portion of the composite video sound signal as a digest display portion. An address for the digest display portion is generated. The digest display portion can be accessed by referring to the address. The accessed digest display portion is displayed or reproduced. The prescribed condition for the sound signal relates to a sound level, a sound frequency, a sound spectrum, or a sound waveform feature.

An example of the method in U.S. Pat. No. 6,160,950 has a step of detecting a sound level represented by a composite video sound signal, a step of comparing the detected sound level with a reference sound level, and a step of deriving a continuation time range during which the result of the comparison indicates that the detected sound level remains greater than the reference sound level. A portion of the composite video sound signal which exists in the derived continuation time range is labeled as a digest display portion.

### SUMMARY OF THE INVENTION

It is an object of this invention to provide an apparatus for generating data representing a digest of a moving-image file or files which is appropriate to the genre of the contents of the file or files.

It is another object of this invention to provide a method of generating data representing a digest of a moving-image file or files which is appropriate to the genre of the contents of the file or files.

A first aspect of this invention provides a digest generating apparatus comprising first means for generating a tag for each of moving-image files, the tag including genre information and event identification information, the genre information representing a genre of an event relating to the moving-image file, the event identification information identifying the event relating to the moving-image file; second means for classifying the moving-image files into groups corresponding to respective events in response to the event identification information in the tags; third means for detecting time intervals in shooting between the moving-image files; fourth means for classifying moving-image files in each of the event corresponding groups into groups corresponding to respective scenes in response to the time intervals detected by the third means; fifth means for extracting portions from moving-image files in each of the scene corresponding groups in response to the genre information in the tags; and sixth means for generating data representative of a digest from the portions extracted by the fifth means.

A second aspect of this invention is based on the first aspect thereof, and provides a digest generating apparatus wherein the fourth means comprises means for deciding a threshold value concerning the genre of the event in response to the genre information; and means for classifying the moving-image files in the event corresponding group into the scene corresponding groups in response to the detected time intervals and the decided threshold value.

A third aspect of this invention is based on the first aspect thereof, and provides a digest generating apparatus wherein the fourth means comprises means for providing a maximum value concerning the genre of the event in response to the genre information; means for deciding a threshold value concerning the genre of the event in response to attribute information about the moving-image files in the event corresponding group; means for comparing the provided maximum value and the decided threshold value to generate a comparison result; means for selecting the provided maximum value as a final threshold value when the comparison result indicates that the decided threshold value is equal to or greater than the provided maximum value; means for selecting the decided threshold value as a final threshold value when the comparison result indicates that the decided threshold value is smaller than the provided maximum value; and means for classifying the moving-image files in the event corresponding group into the scene corresponding groups in response to the detected time intervals and the final threshold value.

A fourth aspect of this invention is based on the first aspect thereof, and provides a digest generating apparatus wherein the fourth means comprises means for providing a minimum value concerning the genre of the event in response to the genre information; means for deciding a threshold value concerning the genre of the event in response to attribute information about the moving-image files in the event corresponding group; means for comparing the provided minimum value and the decided threshold value to generate a comparison result; means for selecting the provided minimum value as a final threshold value when the comparison result indicates that the decided threshold value is equal to or smaller than the provided minimum value; means for selecting the decided threshold value as a final threshold value when the comparison result indicates that the decided threshold value is greater than the provided minimum value; and means for classifying the moving-image files in the event corresponding group into the scene corresponding groups in response to the detected time intervals and the final threshold value.

A fifth aspect of this invention is based on the first aspect thereof, and provides a digest generating apparatus wherein the fourth means comprises means for deciding a threshold value concerning the genre of the event in response to attribute information about the moving-image files in the event corresponding group; means for deciding whether or not the genre of the event is a specified genre; means for adjusting the decided threshold value in response to a prescribed coefficient and labeling the adjusted threshold value as a final threshold value when it is decided that the genre of the event is the specified genre; means for labeling the decided threshold value as a final threshold value when it is decided that the genre of the event is not the specified genre; and means for classifying the moving-image files in the event corresponding group into the scene corresponding groups in response to the detected time intervals and the final threshold value.

A sixth aspect of this invention is based on the third aspect thereof, and provides a digest generating apparatus wherein the fourth means comprises means for calculating a time length of the event from the attribute information, and means for deciding the threshold value concerning the genre of the event in response to the calculated time length.

A seventh aspect of this invention is based on the third aspect thereof, and provides a digest generating apparatus wherein the fourth means comprises means for calculating an average of time intervals in shooting between the moving-image files in the event corresponding group from the attribute information, and means for deciding the threshold value concerning the genre of the event in response to the calculated average.

An eighth aspect of this invention is based on the third aspect thereof, and provides a digest generating apparatus wherein the attribute information represents shooting places relating to the moving-image files in the event corresponding group.

A ninth aspect of this invention provides a digest generating method comprising the steps of classifying moving-image files into groups corresponding to respective events in response to event identification information in tags for the respective moving-image files, wherein each of the tags includes genre information and event identification information, the genre information representing a genre of an event relating to the present moving-image file, the event identification information identifying the event relating to the present moving-image file; detecting time intervals in shooting between the moving-image files; classifying moving-image files in each of the event corresponding groups into groups corresponding to respective scenes in response to the detected time intervals; extracting portions of moving-image files in each of the scene corresponding groups in response to the genre information in the tags; and generating data representative of a digest from the extracted portions.

A tenth aspect of this invention provides a digest generating apparatus comprising first means for classifying moving-image files into groups corresponding to respective events; second means for detecting time intervals in shooting between the moving-image files; third means for classifying moving-image files in each of the event corresponding groups into groups corresponding to respective scenes in response to the time intervals detected by the second means; fourth means for detecting a genre of each of the events; fifth means for extracting portions from moving-image files in each of the scene corresponding groups in response to the genre detected by the fourth means; and sixth means for generating data representative of a digest from the portions extracted by the fifth means.

This invention has the following advantages. It is possible to optimally classify a plurality of moving-image files into groups corresponding to respective scenes. Furthermore, with respect to the generation of a digest, it is possible to extract optimal portions from moving-image files for each genre.

### BRIEF DESCRIPTION OF THE DRAWINGS

FIG. 1 is an operation flow diagram of a digest generating apparatus according to a first embodiment of this invention.

FIG. 2 is a diagram of an example of the relation among events, genres, scene classification threshold values, and digest generating methods.

FIG. 3 is a flowchart of a first segment of a control program for a computer in the digest generating apparatus of FIG. 1.

FIG. 4 is a diagram of an example of moving-image files, scenes, photographing start date and time about each of the moving-image files, photographing end date and time about each of the moving-image files, and time intervals in photographing between ones of the moving-image files and preceding ones.

FIG. 5 is a flowchart of a second segment of the control program for the computer in the digest generating apparatus of FIG. 1.

FIG. 6 is a flow diagram of a portion of a step S303 in FIG. 5 which is executed when a detected genre is “trip and leisure”, and which corresponds to a digest generating method “A”.

FIG. 7 is a flow diagram of a portion of the step S303 in FIG. 5 which is executed when the detected genre is “athletic meeting and sport”, and which corresponds to a digest generating method “B”.

FIG. 8 is a flow diagram of a portion of the step S303 in FIG. 5 which is executed when the detected genre is “child and pet”, and which corresponds to a digest generating method “C”.

FIG. 9 is a flow diagram of a portion of the step S303 in FIG. 5 which is executed when the detected genre is “marriage ceremony and party”, and which corresponds to a digest generating method “D”.

FIG. 10 is a diagram of an example of moving-image files and portions extracted therefrom in the digest generating method “A”.

FIG. 11 is a diagram of an example of moving-image files and portions extracted therefrom in the digest generating method “B”.

FIG. 12 is a diagram of an example of moving-image files and portions extracted therefrom in the digest generating method “C”.

FIG. 13 is a diagram of an example of a moving-image file and portions extracted therefrom in the digest generating method “D”.

FIG. 14 is a diagram of an example of moving-image files, portions extracted therefrom, and a digest generated by connecting the extracted portions for a scene 1.

FIG. 15 is a diagram of an example of moving-image files, portions extracted therefrom, and a digest generated by connecting the extracted portions for a scene 2.

FIG. 16 is a diagram of an example of moving-image files, portions extracted therefrom, and a digest generated by connecting the extracted portions for a scene 3.

FIG. 17 is a diagram of the digests for the scenes 1, 2, and 3, and an overall digest generated by connecting them.

FIG. 18 is a flowchart of a segment of a control program for a computer in a digest generating apparatus according to a second embodiment of this invention.

FIG. 19 is a block diagram of the digest generating apparatus in the first embodiment of this invention.

### DETAILED DESCRIPTION OF THE INVENTION

### First Embodiment

There is the following hierarchy. A plurality of different genres are predetermined. Each genre contains one or more different events. Examples of the events are a trip, a leisure, an athletic meeting, a sport, a child, a pet, a marriage ceremony, and a party. For example, a trip and a leisure are in a first genre. An athletic meeting and a sport are in a second genre. A child and a pet are in a third genre. A marriage ceremony and a party are in a fourth genre. Basically, a moving-image file is generated each time shooting is performed in an event. One or more moving-image files are generated in connection with each of desired scenes during an event. Accordingly, moving-image files can be classified into groups corresponding to respective events. Furthermore, moving-image files in a same event-corresponding group can be classified into groups corresponding to respective scenes in a related event.

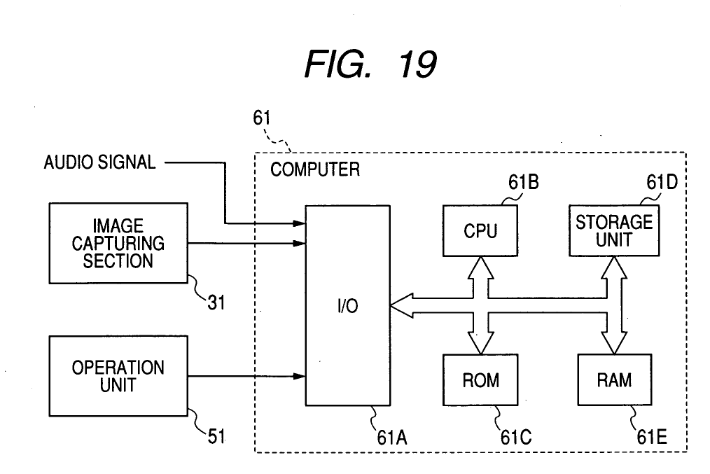

FIG. 19 shows a digest generating apparatus according to a first embodiment of this invention. Preferably, the digest generating apparatus is provided in a video camera. The digest generating apparatus performs classification of moving-image files in view of the above-mentioned hierarchy. Furthermore, in response to the result of the classification, the digest generating apparatus generates data representing a digest of the contents of moving-image files in each event-corresponding group (moving-image files relating to each event).

As shown in FIG. 19, the digest generating apparatus includes an image capturing section 31, an operation unit 51, and a computer 61. The computer 61 has an input/output port 61A, a CPU 61B, a ROM 61C, a storage unit 61D, and a RAM 61E which are connected by a bus. The image capturing section 31 and the operation unit 51 are connected to the input/output port 61A of the computer 61.

The image capturing section 31 repetitively captures an image of a subject or a target scene, and generates a video signal representing a stream of moving images formed by the respective captured images. The image capturing section 31 outputs the video signal to the input/output port 61A of the computer 61.

There is a sound capturing section (not shown) for capturing sounds in synchronism with the images captured by the image capturing section 31. The sound capturing section generates an audio signal representing the captured sounds. The sound capturing section outputs the audio signal to the input/output port 61A of the computer 61.

The operation unit 51 can be actuated by a user. The operation unit 51 generates a command signal or a tag signal in accordance with the actuation thereof by the user. The operation unit 51 outputs the command signal or the tag signal to the input/output port 61A of the computer 61.

The computer 61 or the CPU 61B operates in accordance with a control program (a computer program) stored in the ROM, the storage unit 61D, or the RAM 61E. The control program is designed to enable the computer 61 or the CPU 61B to implement actions mentioned hereafter.

The computer 61 generates a moving-image file from the video signal outputted by the image capturing section 31 and the audio signal outputted by the sound capturing section during every shooting performed in an event. The moving-image file consists of data formatted in a file and basically representing a stream of moving images concerning the event and sounds synchronized with the moving-image stream. The moving-image file has not only video and audio information (video and audio data) but also data representing the date and time of the shooting by the image capturing section 31. To this end, the computer 61 may include a calendar and a clock. The CPU 61B stores the moving-image file into the storage unit 61D. The date and time signal in the moving-image file may represent the date and time of the recording of the file into the storage unit 61D. Preferably, the storage unit 61D includes a memory, a combination of a hard disc and a drive therefore, or a combination of a writable optical disc and a drive therefore.

Normally, one or more moving-image files are stored in the storage unit 61D. Tags (data pieces representing tags) are given to the moving-image files, respectively. The tags are also stored in the storage unit 61D.

A tag given to one moving-image file has information representing the genre of the contents of the file (the genre of the event corresponding to the file), and information representing an event ID subordinate to the genre.

For each moving-image file generated by the computer 61, the operation unit 51 is actuated by the user to generate a tag signal corresponding to the file. The computer 61 receives the tag signal from the operation unit 51. The computer 61 generates a tag (a data piece representing a tag) in accordance with the received tag signal. The computer 61 gives the generated tag to the moving-image file. Preferably, the computer 61 stores the tag and the moving-image file into the storage unit 61D.

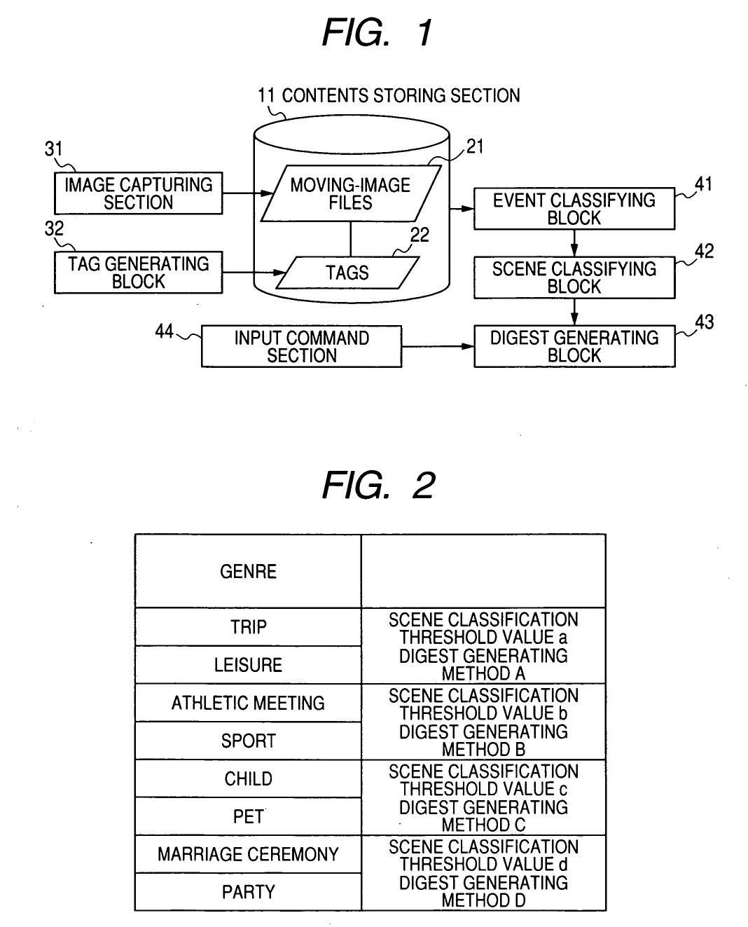

FIG. 1 shows the flow of operation of the digest generating apparatus. With reference to FIG. 1, there are a contents storing section 11, the image capturing section 31, a tag generating block 32, an event classifying block 41, a scene classifying block 42, a digest generating block 43, and an input command section 44.

The contents storing section 11 stores a plurality of moving-image files 21, and tags 22 given to the respective moving-image files 21. The contents storing section 11 is implemented by the storage unit 61D in FIG. 19. The moving-image files 21 are generated from video signals outputted by the image capturing section 31. Each of the moving-image files 21 has not only video contents but also data representing the date and time of the shooting by the image capturing section 31 or the date and time of the recording of the file into the contents storing section 11.

The tag generating block 32 generates the tags 22, and stores them into the contents storing section 11. The tag generating block 32 gives the generated tags to the moving-image files respectively. The tag generating block 32 is implemented by the operation unit 51 and the computer 61 in FIG. 19. The moving-image files correspond to an event or events. Generally, one or more moving-image files correspond to one event. Examples of the events are an athletic meeting and a trip. A tag given to one moving-image file has genre information representing the genre (the type) of the event corresponding to the file, and numerical value information for identifying the event. The numerical value information is also called the event identification information.

A tag takes a form having a set of genre information and event identification information (numerical value information) successively arranged in that order. A first exemplary tag is “athletic meeting 1” in which “athletic meeting” is genre information and “1” is event identification information. A second exemplary tag is “athletic meeting 2” in which “athletic meeting” is genre information and “2” is event identification information. A third exemplary tag is “trip 1” in which “trip” is genre information and “1” is event identification information.

For example, an athletic meeting 1 and an athletic meeting 2 are in a same genre. The numerical value information (the event identification information) enables the discrimination between the athletic meeting 1 and the athletic meeting 2, that is, the discrimination between the events in the same genre. Accordingly, the numerical value information is unique to the related event.

Giving tags to respective moving-image files may be implemented in a place outside the digest generating apparatus. In this case, the tag generating block 32 is removed from the digest generating apparatus.

It should be noted that the contents storing section 11, the image capturing section 31, and the input command section 44 may be provided in places outside the digest generating apparatus.

In this description, “event” generally means the type of shot contents such as an athletic meeting or a trip. More specifically, “event” means a unit for moving-images files given a common tag. On the other hand, “genre” means the type of the contents of an event (for example, an athletic meeting or a trip). Accordingly, one event corresponds to one genre. The genre of the contents of each moving-image file is identified by the genre information in the tag given to the file. Events in a same genre are identified by the event identification information (the numerical value information) in the tags given to the related moving-image files. For events in a same genre, the event identification information varies from event to event. For events in different genres, the event identification information may vary from event to event.

With reference to FIG. 2, there are examples of different genres. Specifically, a trip and a leisure are in a first genre while an athletic meeting and a sport are in a second genre. A child and a pet are in a third genre. A marriage ceremony and a party are in a fourth genre. The tag generating block 32 gives each moving image file a tag having genre information representing a corresponding genre.

A threshold value for scene classification and a digest generating method are decided on a genre-by-genre basis. Specifically, the genre “trip and leisure” is assigned a scene classification threshold value “a” and a digest generating method “A”. The genre “athletic meeting and sport” is assigned a scene classification threshold value “b” and a digest generating method “B”. The genre “child and pet” is assigned a scene classification threshold value “c” and a digest generating method “C”. The genre “marriage ceremony and party” is assigned a scene classification threshold value “d” and a digest generating method “D”.

With reference back to FIG. 1, the event classifying block 41 accesses the moving-image files 21 in the contents storing section 11. The event classifying block 41 classifies the moving-image files 21 into groups according to the genre information and the event identification information in the tags 22 given to the files 21. The groups correspond to different events, respectively. The events are, for example, an athletic meeting 1, an athletic meeting 2, and a trip 1. The event classifying block 41 is implemented by the computer 61 or the CPU 61B in FIG. 19. In the case where for events in same and different genres, event identification information is designed to vary from event to event, the event classifying block 41 classifies the moving-image files 21 into event-corresponding groups according to only the event identification information in the tags 22 given to the files 21.

The scene classifying block 42 receives the result of the classification by the event classifying block 41. The scene classifying block 42 classifies moving-image files in each event-corresponding group, that is, each event into groups through the use of a scene classification threshold value (“a”, “b”, “c”, or “d” in FIG. 2) assigned to the genre of the event. The groups correspond to different scenes, respectively. The scene classifying block 42 is implemented by the computer 61 or the CPU 61B in FIG. 19.

The detailed operation of the scene classifying block 42 is as follows. The scene classifying block 42 calculates the time intervals in shooting between moving-image files in each event-corresponding group (each event). As will be explained later, two adjacent moving-image files spaced at a time interval in shooting which is equal to or greater than a certain threshold value (a scene classification threshold value) are concluded to correspond to different scenes. On the other hand, two adjacent moving-image files spaced at a time interval in shooting which is smaller than the certain threshold value are concluded to correspond to a same scene. The scene classifying block 42 decides the certain threshold value for each genre.

In the case of the genre “trip and leisure”, moving-image files tend to be generated while the user travels to several places. It is desirable to classify moving-image files relating to respective places into different scene-corresponding groups. Generally, the user does not perform shooting during the movement from one place to another. Thus, shooting at one place and that at the next place tend to be spaced at a long time interval. Accordingly, regarding the genre “trip and leisure”, the scene classifying block 42 regards two adjacent moving-image files spaced at a time interval in shooting which is equal to or greater than a large threshold value as corresponding to different scenes. On the other hand, the scene classifying block 42 regards two adjacent moving-image files spaced at a time interval in shooting which is smaller than the large threshold value as corresponding to a same scene.

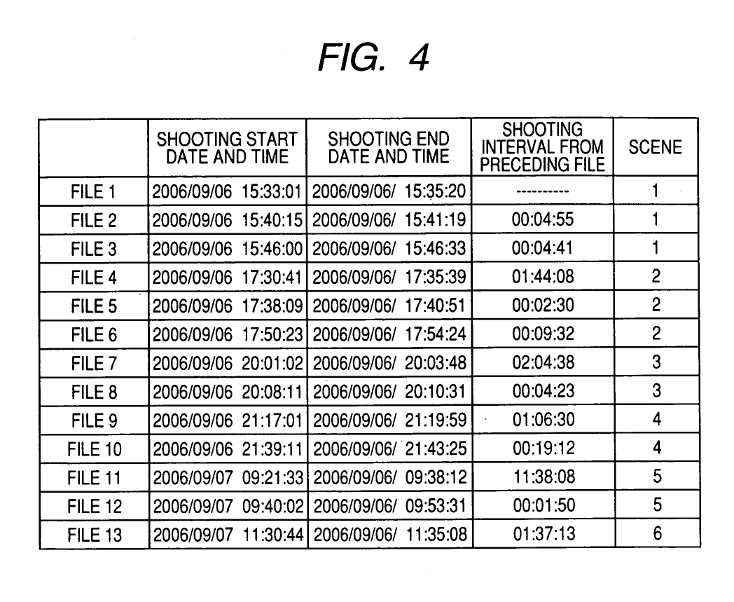

With reference to FIG. 4, there are moving-image files 1, 2, . . . , 13 corresponding to a same event such as a trip. Each of the moving-image files 1, 2, . . . , 13 has data representing the date and time of the start of the related shooting, and the date and time of the end thereof. The moving-image files 1, 2, . . . , 13 are sequentially arranged in the order of shooting date and time. The scene classification threshold value “a” for the genre “trip and leisure” is equal to, for example, 30 minutes. It should be noted that the scene classification threshold value “a” may be equal to 1 hour, 2 hours, 1 day, or more days.

The scene classifying block 42 calculates the time interval in shooting between each one and the next among the moving-image files 1, 2, . . . , 13. The scene classifying block 42 compares each calculated time interval with the scene classification threshold value “a” (equal to, for example, 30 minutes). When a calculated time interval is equal to or greater than the scene classification threshold value “a”, the scene classifying block 42 regards two related moving-image files as corresponding to different scenes. On the other hand, when the calculated time interval is smaller than the scene classification threshold value “a”, the scene classifying block 42 regards two related moving-image files as corresponding to a same scene. Accordingly, the scene classifying block 42 classifies the moving-image files 1, 2, . . . , 13 into 6 scene-corresponding groups (scenes 1, 2, 3, 4, 5, and 6 in FIG. 4).

In the case of the genre “athletic meeting and sport”, it is desirable to classify moving-image files relating to respective races or respective games into different scene-corresponding groups. Generally, the time intervals between races or games are shorter than movement times in a trip. Accordingly, the scene classification threshold value “b” for the genre “athletic meeting and sport” is equal to, for example, 10 minutes. The scene classifying block 42 classifies moving-image files into scene-corresponding groups in response to the scene classification threshold value “b”.

In a typical example, moving-image files in the genre “child and pet” are generated during a long term. In another typical example, moving-image files in the genre “child and pet” are generated during an event such as a trip. Thus, the scene classification threshold value “c” for the genre “child and pet” is changed depending on the time length of a related event. The scene classifying block 42 calculates the difference between the shooting start time of the first moving-image file corresponding to the event and the shooting end time of the last moving-image file corresponding thereto. When the calculated difference is equal to or greater than 3 days, the scene classifying block 42 classifies moving-image files into scene-corresponding groups according to day. Thus, moving-image files in a same day are regarded as corresponding to a same scene. On the other hand, moving-image files in different days are regarded as corresponding to different scenes.

When the calculated difference is less than 3 days, the scene classifying block 42 sets the scene classification threshold value “c” to, for example, 10 minutes. Then, the scene classifying block 42 classifies moving-image files into scene-corresponding groups in response to the scene classification threshold value “c”.

In the case of the genre “marriage ceremony and party”, it is desirable to classify moving-image files relating to respective places into different scene-corresponding groups. Usually, user's movement between places tends to take 30 minutes or longer. Accordingly, the scene classification threshold value “d” for the genre “marriage ceremony and party” is equal to, for example, 30 minutes. The scene classifying block 42 classifies moving-image files into scene-corresponding groups in response to the scene classification threshold value “d”.

When the genre is not set, the scene classifying block 42 equalizes the scene classification threshold value to, for example, 20 minutes. Then, the scene classifying block 42 classifies moving-image files into scene-corresponding groups in response to the scene classification threshold value.

In this way, the scene classifying block 42 decides the scene classification threshold value depending on the genre of a related event. Thus, the scene classification threshold value can be optimized for each genre. The scene classifying block 42 classifies moving-image files into scene-corresponding groups in response to the decided scene classification threshold value. Specifically, the scene classifying block 42 compares the calculated time intervals in shooting between moving-image files in each event-corresponding group (each event) with the decided scene classification threshold value. Then, the scene classifying block 42 implements the classification in response to the results of the comparison. In more detail, two adjacent moving-image files spaced at a time interval in shooting which is equal to or greater than the decided scene classification threshold value are concluded to correspond to different scenes. On the other hand, two adjacent moving-image files spaced at a time interval in shooting which is smaller than the decided scene classification threshold value are concluded to correspond to a same scene.

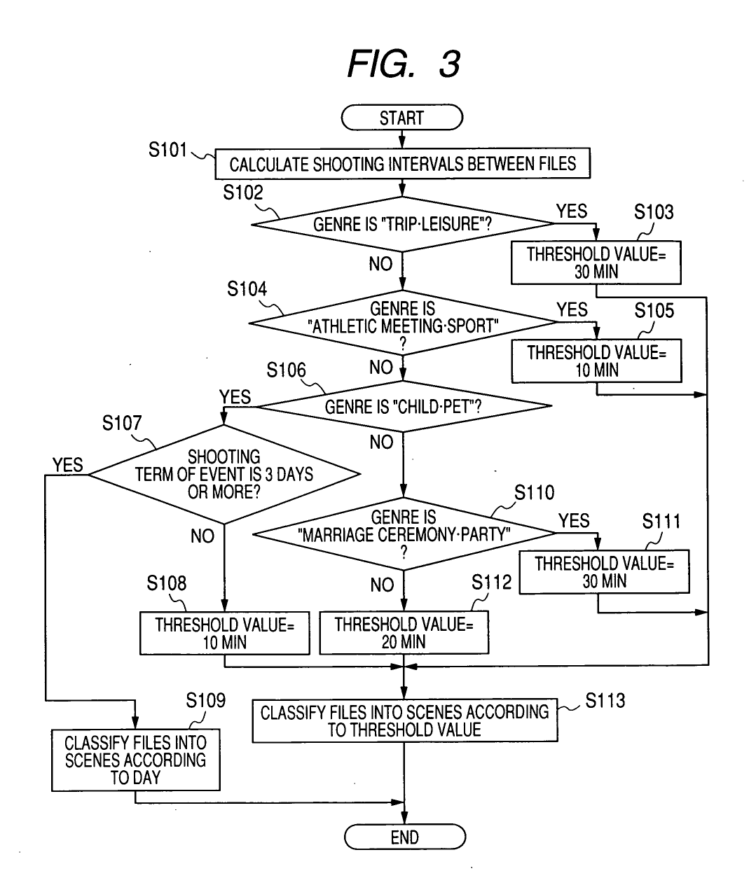

FIG. 3 is a flowchart of a segment of the control program for the computer 61 (the CPU 61B) which relates to the scene classifying block 42, and which is executed for each event-corresponding group (each event).

As shown in FIG. 3, a first step S101 of the program segment calculates the time intervals in shooting between moving-image files in the event-corresponding group (the event).

A step S102 following the step S101 decides whether or not the genre of the event is “trip and leisure”. When the genre of the event is “trip and leisure”, the program advances from the step S102 to a step S103. Otherwise, the program advances from the step S102 to a step S104.

The step S103 sets a scene classification threshold value to 30 minutes. After the step S103, the program advances to a step S113.

The step S104 decides whether or not the genre of the event is “athletic meeting and sport”. When the genre of the event is “athletic meeting and sport”, the program advances from the step S104 to a step S105. Otherwise, the program advances from the step S104 to a step S106.

The step S105 sets the scene classification threshold value to 10 minutes. After the step S105, the program advances to the step S113.

The step S106 decides whether or not the genre of the event is “child and pet”. When the genre of the event is “child and pet”, the program advances from the step S106 to a step S107. Otherwise, the program advances from the step S106 to a step S110.

The step S107 calculates the difference between the shooting start time of the first moving-image file corresponding to the event and the shooting end time of the last moving-image file corresponding thereto. The step S107 compares the calculated difference with 3 days. When the calculated difference is equal to or greater than 3 days, the program advances from the step S107 to a step S109. Otherwise, the program advances from the step S107 to a step S108.

The step S108 sets the scene classification threshold value to 10 minutes. After the step S108, the program advances to the step S113.

The step S109 classifies the moving-image files in the event-corresponding group (the event) into scene-corresponding groups according to day. Thus, moving-image files in a same day are regarded as corresponding to a same scene. On the other hand, moving-image files in different days are regarded as corresponding to different scenes. The step S109 stores data representative of the result of the scene-based classification into the storage unit 61D or the RAM 61E. After the step S109, the current execution cycle of the program segment ends.

The step S110 decides whether or not the genre of the event is “marriage ceremony and party”. When the genre of the event is “marriage ceremony and party”, the program advances from the step S110 to a step S111. Otherwise, the program advances from the step S110 to a step S112.

The step S111 sets the scene classification threshold value to 30 minutes. After the step S111, the program advances to the step S113.

The step S112 sets the scene classification threshold value to 20 minutes. After the step S112, the program advances to the step S113.

The step S113 compares the calculated time intervals in shooting between the moving-image files in the event-corresponding group (the event) with the scene classification threshold value. Then, the step S113 implements the following scene-based classification. Two adjacent moving-image files spaced at a time interval in shooting which is equal to or greater than the scene classification threshold value are concluded to correspond to different scenes. On the other hand, two adjacent moving-image files spaced at a time interval in shooting which is smaller than the scene classification threshold value are concluded to correspond to a same scene. The step S113 stores data representative of the result of the scene-based classification into the storage unit 61D or the RAM 61E. After the step S113, the current execution cycle of the program segment ends.

With reference back to FIG. 1, the digest generating block 43 receives the result of the classification by the scene classifying block 42. The digest generating block 43 generates data representative of an overall digest from scene-corresponding groups of moving-image files relating to each event. The digest generating block 43 is implemented by the computer 61 or the CPU 61B in FIG. 19.

The details of operation of the digest generating block 43 are as follows. The digest generating block 43 decides the time length of an overall digest to be generated for one event. Preferably, the digest generating block 43 automatically sets the time length of an overall digest proportional to the total shooting time or the number of related moving-image files. Alternatively, the digest generating block 43 may decide the time length of an overall digest in accordance with user's choice represented by a command signal inputted via the input command section 44. The input command section 44 is implemented by the operation unit 51 in FIG. 19. The time length of an overall digest is set to, for example, 90 seconds. It should be noted that the input command section 44 may be omitted when the time length of an overall digest is automatically decided.

The digest generating block 43 generates data representing digests of captured moving images in all the scenes from the moving-image files in the scene-corresponding groups for each event. The digest generating block 43 combines the generated digests into an overall digest for the event, and generates data representing the overall digest. Specifically, the digest generating block 43 decides the time length of a digest to be generated for each scene. The sum of the decided time lengths of respective digests is equal to the time length of an overall digest. Preferably, the time length of a digest of each scene is set to the result of dividing the time length of an overall digest by the number of the different scenes. Alternatively, the time lengths of digests of the respective scenes may be set in accordance with a ratio between the scenes in total shooting time or number of moving-image files. For example, there are 3 different scenes, and the time length of a digest of each scene is equal to 30 seconds (90 seconds divided by 3).

Thereafter, the digest generating block 43 generates data representative of a digest of captured moving images in each scene from moving-image files in a related scene-corresponding group in a method which is changed among the digest generating methods “A”, “B”, “C”, and “D” (FIG. 2) in accordance with the genre relating to the scene. To this end, the digest generating block 43 refers to the genre information in the tags given to the moving-image files, and thereby detects the genre relating to the scene. Thus, the digest generating method which is used varies from genre to genre. In addition, the threshold value for the scene-based classification varies from genre to genre as previously mentioned.

Finally, the digest generating block 43 combines the generated digests of the respective scenes into an overall digest for one event, and generates data representing the overall digest.

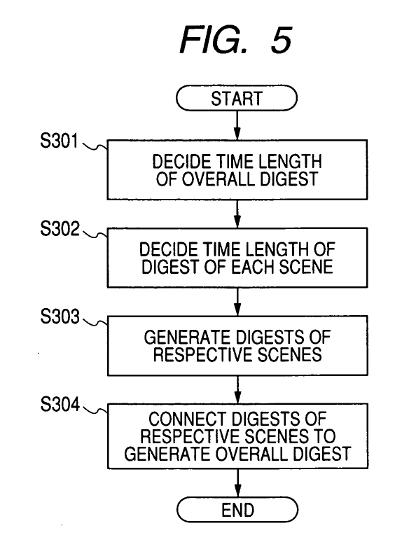

FIG. 5 is a flowchart of a segment of the control program for the computer 61 (the CPU 61B) which relates to the digest generating block 43, and which is executed for each event-corresponding group (each event).

As shown in FIG. 5, a first step S301 of the program segment decides the time length of an overall digest to be generated for the event.

A step S302 following the step S301 decides the time length of a digest to be generated for each of scenes relating to the event. The sum of the decided time lengths of respective digests is equal to the time length of the overall digest.

A step S303 subsequent to the step S302 generates data representative of digests of captured moving images in the respective scenes from the moving-image files in the scene-corresponding groups in a method depending on genre. To this end, the step S303 refers to the genre information in the tags given to the moving-image files, and thereby detects the genre relating to the scenes. The step S303 changes the above method in accordance with the detected genre. The digests have play times equal to the time lengths decided by the step S302.

A step S304 following the step S303 combines the digests of the respective scenes into an overall digest for the event. The step S304 stores data representative of the overall digest into the storage unit 61D or the RAM 61E. After the step S304, the current execution cycle of the program segment ends.

The details of a digest generating method for each genre and the details of the step S303 in FIG. 5 are as follows. The digest generating block 43 or the step S303 detects the genre of the event from the genre information given to the moving-image files in each scene-corresponding group. The digest generating block 43 or the step S303 selects and uses the digest generating method “A” when the detected genre is “trip and leisure”. The digest generating block 43 or the step S303 selects and uses the digest generating method “B” when the detected genre is “athletic meeting and sport”. The digest generating block 43 or the step S303 selects and uses the digest generating method “C” when the detected genre is “child and pet”. The digest generating block 43 or the step S303 selects and uses the digest generating method “D” when the detected genre is “marriage ceremony and party”.

Regarding the genre “trip and leisure”, there are many cases where a subject is decided and a video camera is directed to the subject before shooting is started. In such cases, images to be extracted as portions of a digest tend to occur immediately after the start of the shooting. The digest generating block 43 or the step S303 uses the digest generating method “A” for the genre “trip and leisure”. The digest generating method “A” is designed to identify moving-image files corresponding to a scene in accordance with the result of the scene-based classification, and to extract a head portion from each of the identified moving-image files. In addition, the digest generating method “A” is designed to connect the extracted head portions to generate data representing a digest of the scene.

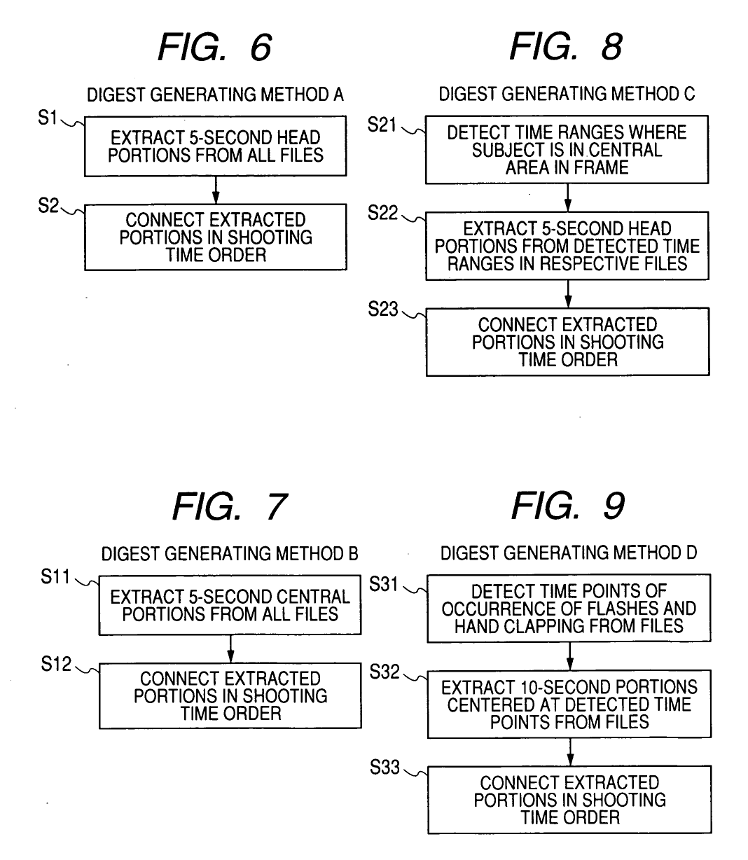

FIG. 6 shows a portion of the step S303 in FIG. 5 which is executed when the detected genre is “trip and leisure”, that is, which corresponds to the digest generating method “A”.

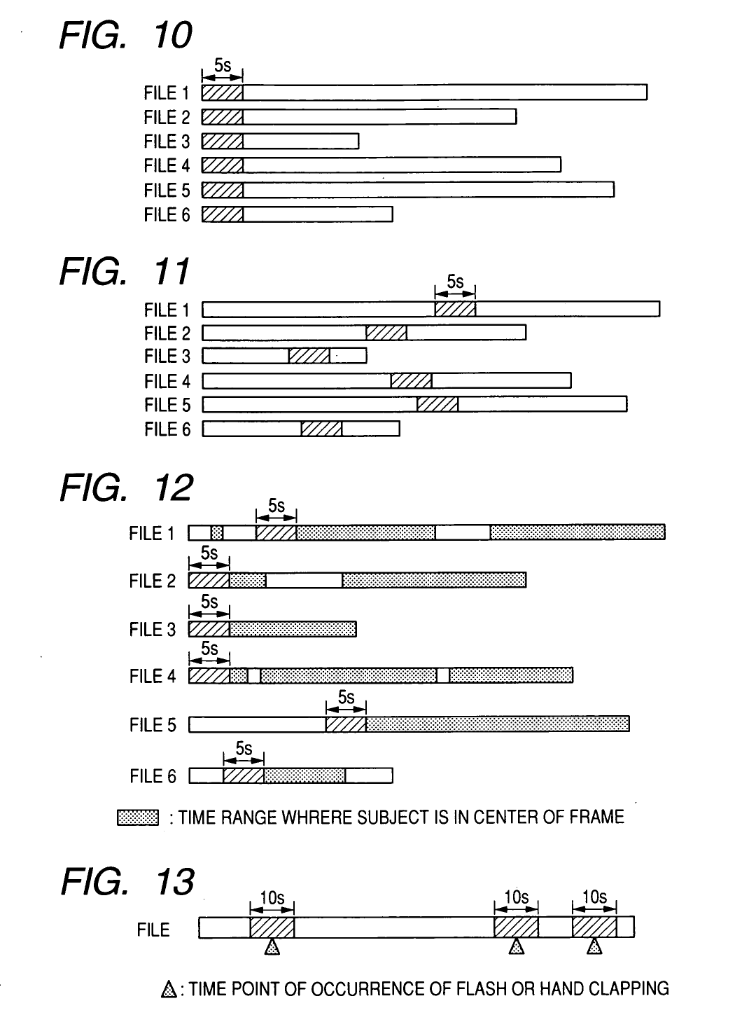

With reference to FIG. 6, a step S1 accesses the storage unit 61D or the RAM 61E to retrieve the data representative of the result of the scene-based classification. The step S1 refers to the result of the scene-based classification, and thereby identifies moving-image files relating to each of the scenes corresponding to the event. The step S1 extracts 5-second head portions from the identified moving-image files. For example, as shown in FIG. 10, 5-second head portions are extracted from moving-image files 1, 2, 3, 4, 5, and 6. Subsequently, a step S2 connects the extracted 5-second head portions in the shooting time order to generate data representing a 30-second digest of each of the scenes. The step S2 stores the data representative of the digests of the respective scenes into the storage unit 61D or the RAM 61E. In the case where the connection of all the extracted 5-second head portions is insufficient for a 30-second play time, for example, in the case where the number of moving-image files relating to the scene is less than 6, head portions longer than 5 seconds are extracted. Alternatively, two or more 5-second portions may be extracted from one moving-image file. On the other hand, in the case where the connection of all the extracted 5-second head portions causes a play time longer than 30 seconds, for example, in the case where the number of moving-image files relating to the scene is greater than 6, 6 are selected from the moving-image files and 5-second head portions are extracted from only the 6 selected moving-image files. In this file selection, higher priorities are given to moving-image files having longer shooting terms and moving-image files spaced from preceding ones at greater time intervals in shooting.

Regarding the genre “athletic meeting and sport”, there are many cases where a video camera is held in an active shooting state while a desired shot is waited for. In such cases, images to be extracted as portions of a digest tend to occur at a mid or later stage of the shooting. The digest generating block 43 or the step S303 uses the digest generating method “B” for the genre “athletic meeting and sport”. The digest generating method “B” is designed to identify moving-image files corresponding to a scene in accordance with the result of the scene-based classification, and to extract a mid or later portion from each of the identified moving-image files. In addition, the digest generating method “B” is designed to connect the extracted mid or later portions to generate data representing a digest of the scene.

FIG. 7 shows a portion of the step S303 in FIG. 5 which is executed when the detected genre is “athletic meeting and sport”, that is, which corresponds to the digest generating method “B”.

With reference to FIG. 7, a step S11 accesses the storage unit 61D or the RAM 61E to retrieve the data representative of the result of the scene-based classification. The step S11 refers to the result of the scene-based classification, and thereby identifies moving-image files relating to each of the scenes corresponding to the event. The step S11 extracts 5-second mid or central portions from the respective identified moving-image files. For example, as shown in FIG. 11, 5-second mid or central portions are extracted from moving-image files 1, 2, 3, 4, 5, and 6. Subsequently, a step S12 connects the extracted 5-second mid or central portions in the shooting time order to generate data representing a 30-second digest of each of the scenes. The step S12 stores the data representative of the digests of the respective scenes into the storage unit 61D or the RAM 61E. In the case where the connection of all the extracted 5-second mid or central portions is insufficient for a 30-second play time, mid or central portions longer than 5 seconds are extracted. Alternatively, two 5-second portions may be extracted from one moving-image file at a ⅓ time place and a ⅔ time place. On the other hand, in the case where the connection of all the extracted 5-second head portions causes a play time longer than 30 seconds, 6 are selected from the moving-image files and 5-second mid or central portions are extracted from only the 6 selected moving-image files. In this file selection, higher priorities are given to moving-image files having longer shooting terms and moving-image files spaced from preceding ones at greater time intervals in shooting.

Regarding the genre “child and pet”, there are many cases where a subject is decided and a video camera is directed to the subject before shooting is started. In such cases, images to be extracted as portions of a digest tend to occur immediately after the start of the shooting. In the genre “child and pet”, there are many cases where a subject occupies a central area in the frame. When a central area of the frame moves differently from motions of the other areas in the frame or when a central area of the frame differs in color from the other areas in the frame, there is a high chance that a subject occupies the central area in the frame. The digest generating block 43 or the step S303 uses the digest generating method “C” for the genre “child and pet”. The digest generating method “C” is designed to identify moving-image files corresponding to a scene in accordance with the result of the scene-based classification, and to extract a head portion, which has a high chance that a subject occupies a central area in the frame, from each of the identified moving-image files. In addition, the digest generating method “C” is designed to connect the extracted head portions to generate data representing a digest of the scene.

FIG. 8 shows a portion of the step S303 in FIG. 5 which is executed when the detected genre is “child and pet”, that is, which corresponds to the digest generating method “C”.

With reference to FIG. 8, a step S21 accesses the storage unit 61D or the RAM 61E to retrieve the data representative of the result of the scene-based classification. The step S21 refers to the result of the scene-based classification, and thereby identifies moving-image files relating to each of the scenes corresponding to the event. The step S21 detects, in each of the identified moving-image files, time ranges where a subject occupies a central area in the frame. This detection is based on deciding whether or not a child face occupies a central area in the frame or deciding whether or not a skin-colored zone occupies a central area in the frame. The detection may be based on deciding the positional relation among a skin-colored zone, a hair-colored zone, eye-colored zones, and a mouth-colored zone in the frame. The detection may be based on extracting motion vectors from a stream of images represented by each moving-image file, deciding whether or not a central area in the frame moves differently from motions of the other areas in the frame according to the extracted motion vectors, and concluding that a subject occupies the central area in the frame when the central area moves differently from the motions of the other areas. Subsequently, for each moving-image file, a step S22 selects, from the detected time ranges, one closest to the start end of the file. The step S22 extracts 5-second head portions from the selected time ranges in the respective moving-image files. For example, as shown in FIG. 12, 5-second head portions are extracted from the selected time ranges in moving-image files 1, 2, 3, 4, 5, and 6. Thereafter, a step S23 connects the extracted 5-second head portions in the shooting time order to generate data representing a 30-second digest of each of the scenes. The step S23 stores the data representative of the digests of the respective scenes into the storage unit 61D or the RAM 61E. In the case where the connection of all the extracted 5-second head portions is insufficient for a 30-second play time, head portions longer than 5 seconds are extracted. Alternatively, two or more 5-second portions may be extracted from one moving-image file. On the other hand, in the case where the connection of all the extracted 5-second head portions causes a play time longer than 30 seconds, 6 are selected from the moving-image files and 5-second head portions are extracted from only the 6 selected moving-image files. In this file selection, higher priorities are given to moving-image files having longer shooting terms and moving-image files spaced from preceding ones at greater time intervals in shooting.

Regarding the genre “marriage ceremony and party”, the digest generating block 43 or the step S303 uses the digest generating method “D”. In the genre “marriage ceremony and party”, there are many cases where shooting by a video camera is continued during the event, and a long moving-image file is generated. Accordingly, only one moving-image file tends to correspond to one scene. Furthermore, there are many cases where hand clapping and cheers are given and flashes are fired from still cameras at important scenes. The digest generating method “D” is designed to identify an moving-image file or files corresponding to a scene in accordance with the result of the scene-based classification, and to detect such conditions from video and audio information in the identified moving-image file or files. In addition, the digest generating method “D” is designed to extract portions centered at the time points of the detected conditions from the identified moving-image file or files. Furthermore, the digest generating method “D” is designed to connect the extracted portions to generate data representing a digest of the scene.

FIG. 9 shows a portion of the step S303 in FIG. 5 which is executed when the detected genre is “marriage ceremony and party”, that is, which corresponds to the digest generating method “D”.

With reference to FIG. 9, a step S31 accesses the storage unit 61D or the RAM 61E to retrieve the data representative of the result of the scene-based classification. The step S31 refers to the result of the scene-based classification, and thereby identifies a moving-image file or files relating to each of the scenes corresponding to the event. The step S303 detects time points of the occurrence of flashes and hand clapping from the identified moving-image file or files. Subsequently, a step S32 extracts 10-second portions temporally centered at the detected time points from the identified moving-image file or files. Thereafter, a step S33 connects the extracted 10-second portions in the shooting time order to generate data representing a 30-second digest of the scene. The step S33 stores the data representative of the digest of the scene into the storage unit 61D or the RAM 61E. For example, as shown in FIG. 13, there are 3 time points at which the sound level exceeds the predetermined reference due to the occurrence of cheers or the luminance level exceeds the prescribed reference due to the occurrence of a flash. The 10-second portions centered at the 3 time points are extracted from the moving-image file. The extracted portions are connected to generate the data representing the digest of the scene. In the case where there are 4 or more such time points and the connection of all the extracted 10-second portions causes a play time longer than 30 seconds, the time length of the extracted portions is shortened. Alternatively, 3 may be selected from the time points. In this time point selection, higher priorities are given to time points corresponding to longer continuation of cheers or flashes.

The digest generating block 43 generates data representing digests of respective scenes. The data representing the digests of the respective scenes is stored into the storage unit 61D or the RAM 61E.

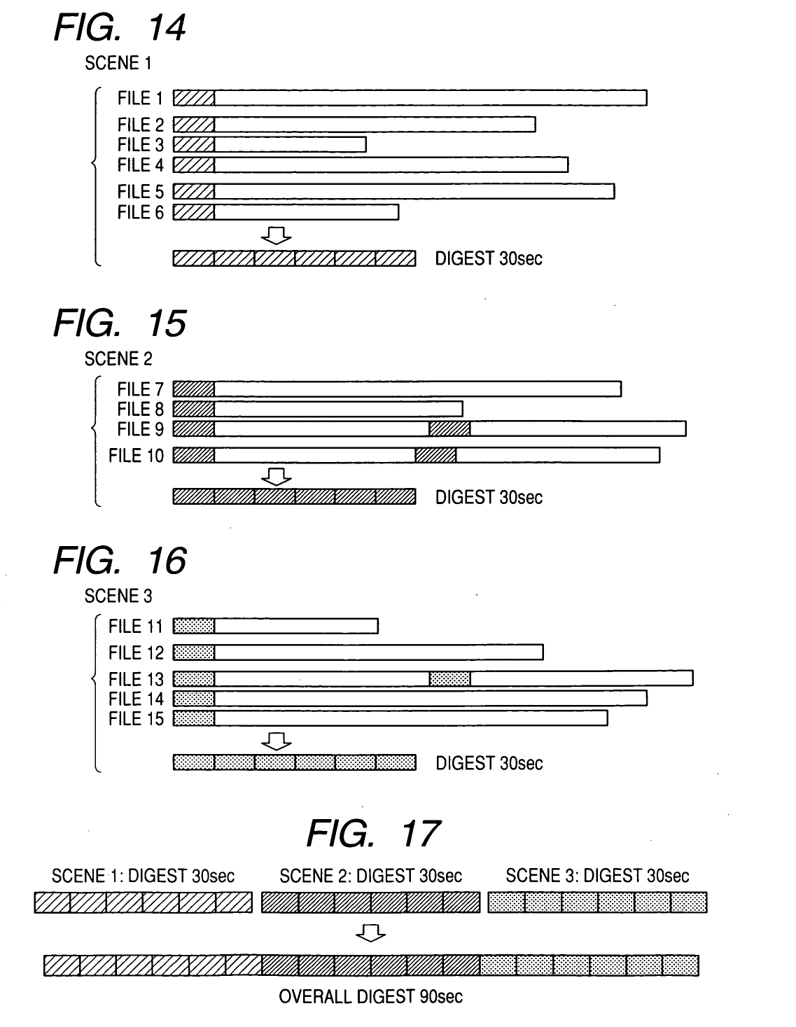

FIGS. 14, 15, and 16 show conditions where moving-image files 1, 2, 3, . . . , and 15 are present for an event and the moving-image files 1-15 are classified into 3 groups assigned to scenes 1, 2, and 3 respectively, and digests are generated for the respective scenes 1, 2, and 3 in the previously-mentioned digest generating method depending on genre. The event is in, for example, the genre “trip and leisure”.

As shown in FIG. 14, 5-second head portions are extracted from the respective moving-image files 1, 2, . . . , and 6 regarding the scene 1 in the digest generating method “A”. The extracted portions are connected to generate data representing a 30-second digest of the scene 1. As shown in FIG. 15, 5-second head portions are extracted from the respective moving-image files 7, 8, . . . , and 10 regarding the scene 2 in the digest generating method “A”. In addition, 5-second mid portions are extracted from the moving-image files 9 and 10 which are the longest and the second longest ones among the moving-image files 7-10. The extracted portions are connected to generate data representing a 30-second digest of the scene 2. As shown in FIG. 16, 5-second head portions are extracted from the respective moving-image files 11, 12, . . . , and 15 regarding the scene 3 in the digest generating method “A”. In addition, a 5-second mid portion is extracted from the moving-image file 13 which is the longest one among the moving-image files 11-15. The extracted portions are connected to generate data representing a 30-second digest of the scene 3.

With reference to FIG. 17, the digest generating block 43 or the step S304 connects the scene-based digests to generate the overall digest of the event. Specifically, the 30-second digests of the scenes 1, 2, and 3 in FIGS. 14, 15, and 16 are connected in the shooting time order to form the 90-second overall digest of the event. The step S304 stores data representative of the overall digest into the storage unit 61D or the RAM 61E.

As previously mentioned, moving-image files are generated from the output signals of the image capturing section 31 and the sound capturing section. Tags are given to the moving-image files, respectively. By referring to the tags, the moving-image files are classified into groups assigned to respective events. The events are grouped according to genre. Two or more different events may be in a same genre. Scene classification threshold values are given for the genres, respectively. In addition, digest generating methods are given for the genres, respectively. Moving-image files relating to an event are classified in response to the scene classification threshold value for the genre of the event into groups assigned to respective scenes. For each of the scenes, portions are extracted from related moving-image files in the digest generating method for the genre of the event. The extracted portions are connected to generate data representing a digest of the scene. In this way, digests of the respective scenes are generated. The generated digests of the respective scenes are connected to generate an overall digest of the event. Accordingly, the generated overall digest can be optimal for the genre of the event. The generation of the overall digest of the event is automatic.

It should be noted that the digest generating method may be fixed regardless of genre. Similarly, the scene classification threshold value may be fixed regardless of genre.

### Second Embodiment

A second embodiment of this invention is similar to the first embodiment thereof except for design changes mentioned hereafter. According to the second embodiment of this invention, a threshold value and a coefficient are decided depending on attribute information about moving-image files relating to one event. The moving-image files relating to the event are classified in response to the threshold value and the coefficient into groups assigned to respective scenes. The attribute information is, for example, a collection of information pieces annexed to the respective moving-image files which represent the shooting dates and times, the shooting terms, the shooting positions, and the genres of the contents of the files. The attribute information may be composed of an information piece representing the sum of the shooting terms of the moving-image files relating to the event, and an information piece representing the number of the moving-image files relating to the event.

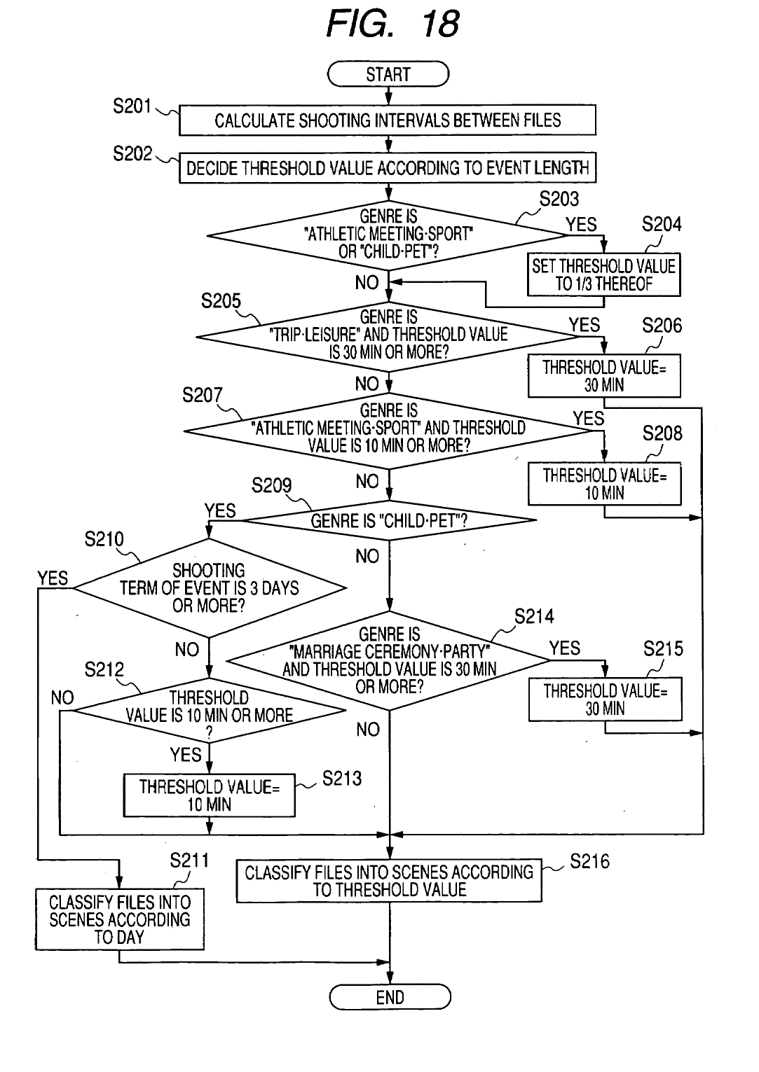

FIG. 18 is a flowchart of a segment of the control program for the computer 61 (the CPU 61B) in the second embodiment of this invention. The program segment in FIG. 18 relates to the scene classifying block 42, and is executed for each event-corresponding group (each event).

As shown in FIG. 18, a first step S201 of the program segment calculates the time intervals in shooting between moving-image files in the event-corresponding group (the event).

A step S202 following the step S201 calculates the time length of the event. Specifically, the step S202 detects the shooting start time of the first one among the moving-image files relating to the event, and the shooting end time of the last one thereamong. The step S202 computes the difference between the detected shooting start time and the detected shooting end time to derive the time length of the event. The step S202 decides a scene classification threshold value depending on the computed difference, that is, the calculated time length of the event. For example, the scene classification threshold value is set to 5% of the calculated time length of the event. In this case, the scene classification threshold value is equal to 30 minutes when the calculated time length of the event is 10 hours. The scene classification threshold value is equal to 15 minutes when the calculated time length of the event is 5 hours.

A step S203 subsequent to the step S202 decides whether or not the genre of the event is “athletic meeting and sport”. In addition, the step S203 decides whether or not the genre of the event is “child and pet”. When the genre of the event is “athletic meeting and sport” or “child and pet”, the program advances from the step S203 to a step S204. Otherwise, the program advances from the step S203 to a step S205.

The step S204 reduces the scene classification threshold value through updating. Specifically, the step S204 divides the scene classification threshold value by 3. In other words, the step S204 multiplies the scene classification threshold value by a coefficient of 1/3. The step S204 equalizes a new scene classification threshold value to the result of the division or the result of the multiplication. Thus, the step S204 updates the scene classification threshold value. After the step S204, the program advances to the step S205.

The steps S203 and S204 are provided in view of the following fact. Regarding the genre “athletic meeting and sport” or the genre “child and pet”, related moving-image files tend to be spaced at relatively short time intervals in shooting. It should be noted that the genres detected by the step S203 may differ from “athletic meeting and sport” and “child and pet”. Furthermore, the coefficient used by the step S204 may differ from 1/3. A coefficient may be added to the original scene classification threshold value to generate a new scene classification threshold value. A power of a coefficient may be used to update the scene classification threshold value. The steps S203 and S204 may be omitted from the program segment in FIG. 18.

The step S205 decides whether or not the genre of the event is “trip and leisure”. In addition, the step S205 compares the scene classification threshold value with 30 minutes. When the genre of the event is “trip and leisure” and the scene classification threshold value is equal to or greater than 30 minutes, the program advances from the step S205 to a step S206. Otherwise, the program advances from the step S205 to a step S207.

The step S206 updates the scene classification threshold value to 30 minutes. After the step S206, the program advances to a step S216.

In the steps S205 and S206, a time interval of 30 minutes is a predetermined maximum (a predetermined upper limit) of the scene classification threshold value for the genre “trip and leisure”. The original scene classification threshold value and the maximum (30 minutes) are compared. When the original scene classification threshold value exceeds the maximum, the step S206 selects the maximum and sets the new classification threshold value to the maximum. On the other hand, when the original scene classification threshold value is equal to or less than the maximum, the original scene classification threshold value is selected and used. It should be noted that the maximum may differ from 30 minutes.

The step S207 decides whether or not the genre of the event is “athletic meeting and sport”. In addition, the step S207 compares the scene classification threshold value with 10 minutes. When the genre of the event is “athletic meeting and sport” and the scene classification threshold value is equal to or greater than 10 minutes, the program advances from the step S207 to a step S208. Otherwise, the program advances from the step S207 to a step S209.

The step S208 updates the scene classification threshold value to 10 minutes. After the step S208, the program advances to the step S216.

In the steps S207 and S208, a time interval of 10 minutes is a predetermined maximum (a predetermined upper limit) of the scene classification threshold value for the genre “athletic meeting and sport”. The original scene classification threshold value and the maximum (10 minutes) are compared. When the original scene classification threshold value exceeds the maximum, the step S208 selects the maximum and sets the new classification threshold value to the maximum. On the other hand, when the original scene classification threshold value is equal to or less than the maximum, the original scene classification threshold value is selected and used. It should be noted that the maximum may differ from 10 minutes.

The step S209 decides whether or not the genre of the event is “child and pet”. When the genre of the event is “child and pet”, the program advances from the step S209 to a step S210. Otherwise, the program advances from the step S209 to a step S214.

The step S210 calculates the difference between the shooting start time of the first moving-image file corresponding to the event and the shooting end time of the last moving-image file corresponding thereto. The step S210 compares the calculated difference with 3 days. When the calculated difference is equal to or greater than 3 days, the program advances from the step S210 to a step S211. Otherwise, the program advances from the step S210 to a step S212.

The step S211 classifies the moving-image files in the event-corresponding group (the event) into scene-corresponding groups according to day. Thus, moving-image files in a same day are regarded as corresponding to a same scene. On the other hand, moving-image files in different days are regarded as corresponding to different scenes. The step S211 stores data representative of the result of the scene-based classification into the storage unit 61D or the RAM 61E. After the step S211, the current execution cycle of the program segment ends.

The step S212 compares the scene classification threshold value with 10 minutes. When the scene classification threshold value is equal to or greater than 10 minutes, the program advances from the step S212 to a step S213. Otherwise, the program advances from the step S212 to the step S216.

The step S213 updates the scene classification threshold value to 10 minutes. After the step S213, the program advances to the step S216.

In the steps S212 and S213, a time interval of 10 minutes is a predetermined maximum (a predetermined upper limit) of the scene classification threshold value for the genre “child and pet”. The original scene classification threshold value and the maximum (10 minutes) are compared. When the original scene classification threshold value exceeds the maximum, the step S213 selects the maximum and sets the new classification threshold value to the maximum. On the other hand, when the original scene classification threshold value is equal to or less than the maximum, the original scene classification threshold value is selected and used. It should be noted that the maximum may differ from 10 minutes.

The step S214 decides whether or not the genre of the event is “marriage ceremony and party”. In addition, the step S214 compares the scene classification threshold value with 30 minutes. When the genre of the event is “marriage ceremony and party” and the scene classification threshold value is equal to or greater than 30 minutes, the program advances from the step S214 to a step S215. Otherwise, the program advances from the step S214 to the step S216.

The step S215 updates the scene classification threshold value to 30 minutes. After the step S215, the program advances to the step S216.

In the steps S214 and S215, a time interval of 30 minutes is a predetermined maximum (a predetermined upper limit) of the scene classification threshold value for the genre “marriage ceremony and party”. The original scene classification threshold value and the maximum (30 minutes) are compared. When the original scene classification threshold value exceeds the maximum, the step S215 selects the maximum and sets the new classification threshold value to the maximum. On the other hand, when the original scene classification threshold value is equal to or less than the maximum, the original scene classification threshold value is selected and used. It should be noted that the maximum may differ from 30 minutes.

The step S216 compares the calculated time intervals in shooting between the moving-image files in the event-corresponding group (the event) with the scene classification threshold value. Then, the step S113 implements the following scene-based classification. Two adjacent moving-image files spaced at a time interval in shooting which is equal to or greater than the scene classification threshold value are concluded to correspond to different scenes. On the other hand, two adjacent moving-image files spaced at a time interval in shooting which is smaller than the scene classification threshold value are concluded to correspond to a same scene. The step S216 stores data representative of the result of the scene-based classification into the storage unit 61D or the RAM 61E. After the step S216, the current execution cycle of the program segment ends.

According to the second embodiment of this invention, moving-image files are generated from the output signals of the image capturing section 31 and the sound capturing section. Tags are given to the moving-image files, respectively. By referring to the tags, the moving-image files are classified into groups assigned to respective events. The events are grouped according to genre. Two or more different events may be in a same genre. Scene classification threshold values are given for the genres, respectively. Initially, the scene classification threshold values are decided depending on the time lengths of events in the genres. For each of the genres, a maximum or an upper limit is predetermined with respect to the related scene classification threshold value. When the initial scene classification threshold value exceeds the maximum, the initial scene classification threshold value is replaced by new one equal to the maximum. In this case, the new scene classification threshold value is used. On the other hand, when the initial scene classification threshold value does not exceed the maximum, the initial scene classification threshold value is used. In addition, digest generating methods are given for the genres, respectively. Moving-image files relating to one event are classified in response to the scene classification threshold value for the genre of the event into groups assigned to respective scenes. This scene-based classification of the moving-image files can be optimized by the time length of the event. For each of the scenes, portions are extracted from related moving-image files in the digest generating method for the genre of the event. The extracted portions are connected to generate data representing a digest of the scene. In this way, digests of the respective scenes are generated. The generated digests of the respective scenes are connected to generate an overall digest of the event. Accordingly, the generated overall digest can be optimal for the genre of the event. The generation of the overall digest of the event is automatic.

It should be noted that the steps S203-S215 may be omitted from the program segment in FIG. 18.

### Third Embodiment

A third embodiment of this invention is similar to the second embodiment thereof except for design changes mentioned hereafter. The second embodiment of this invention sets a minimum or a lower limit rather than a maximum or an upper limit with respect to a scene classification threshold value for each genre.

Initially, the scene classification threshold values are decided depending on the time lengths of events in the genres. For each of the genres, a minimum or a lower limit is predetermined with respect to the related scene classification threshold value. When the initial scene classification threshold value is less than the minimum, the initial scene classification threshold value is replaced by new one equal to the minimum. In this case, the new scene classification threshold value is used. On the other hand, when the initial scene classification threshold value is equal to or greater than the minimum, the initial scene classification threshold value is used.

Regarding the genre “trip and leisure”, there is a certain chance that a related event is short, and the initial scene classification threshold value therefore is excessively small. In the genre “trip and leisure”, it is desirable to implement the scene-based classification of moving-image files according to time interval comparable with a user's movement time. Accordingly, the minimum of the scene classification threshold value for the genre “trip and leisure” is set to a time interval of, for example, 10 minutes which is equal to a generally expected user's movement time. When the initial scene classification threshold value is less than the minimum (10 minutes), the initial scene classification threshold value is replaced by new one equal to the minimum. In this case, the new scene classification threshold value is used. On the other hand, when the initial scene classification threshold value is equal to or greater than the minimum, the initial scene classification threshold value is used.

### Fourth Embodiment

A fourth embodiment of this invention is similar to the second embodiment thereof except for design changes mentioned hereafter. The fourth embodiment of this invention calculates the average of the time intervals in shooting between moving-image files relating to each event. The fourth embodiment of this invention decides the initial scene classification threshold values for the respective genres depending on the calculated averages rather than the time lengths of related events. For example, the scene classification threshold values are set to the calculated averages, respectively.

### Fifth Embodiment

A fifth embodiment of this invention is similar to the second embodiment thereof except for design changes mentioned hereafter. In the fifth embodiment of this invention, the step S202 (see FIG. 18) calculates the average of the time intervals in shooting between moving-image files relating to the event. Furthermore, the step S202 calculates the time length of the event. The step S202 decides a scene classification threshold value depending on the calculated average and the calculated time length of the event.

In the case where 5 moving-image files relate to the event and are spaced at time intervals of 5 minutes, 10 minutes, 30 minutes, and 3 minutes in shooting, the time-interval average calculated by the step S202 is equal to 12 minutes. The step S202 decides a first basic threshold value depending on the calculated time-interval average. For example, the first basic threshold value is equal to the calculated time-interval average, that is, 12 minutes.

Furthermore, the step S202 calculates the time length of the event. The step S202 decides a second basic threshold value depending on the calculated time length.

Basically, the step S202 selects greater one or smaller one of the first and second basic threshold values as a scene classification threshold value. Alternatively, the step S202 may calculate the average of the first and second basic threshold values. In this case, the step S202 sets the scene classification threshold value to the calculated threshold-value average.

Preferably, the step S202 decides whether at least one of the time intervals in shooting between the moving-image files relating to the event is equal to or greater than a prescribed reference. When at least one of the time intervals is equal to or greater than the prescribed reference, the step S202 uses the second basic threshold value as a scene classification threshold value.

Preferably, the step S202 detects the number of the moving-image files relating to the event. The step S202 compares the detected file number with a prescribed number. When the detected file number is equal to or greater than the prescribed number, the step S202 uses the first basic threshold value as a scene classification threshold value.

According to the fifth embodiment of this invention, moving-image files are generated from the output signals of the image capturing section 31 and the sound capturing section. Tags are given to the moving-image files, respectively. By referring to the tags, the moving-image files are classified into groups assigned to respective events. The events are grouped according to genre. Two or more different events may be in a same genre. Scene classification threshold values are given for the genres, respectively. Initially, a first basic threshold value is decided depending on the average of the time intervals in shooting between the moving-image files relating to each event, and a second basic threshold value is decided depending on the time length of the event. Preferably, one of the first and second basic threshold values is used as a scene classification threshold value for the genre of the event. In addition, digest generating methods are given for the genres, respectively. The moving-image files relating to the event are classified in response to the scene classification threshold value into groups assigned to respective scenes. This scene-based classification of the moving-image files can be optimized by the time intervals in shooting between the moving-image files or the time length of the event. For each of the scenes, portions are extracted from related moving-image files in the digest generating method for the genre of the event. The extracted portions are connected to generate data representing a digest of the scene. In this way, digests of the respective scenes are generated. The generated digests of the respective scenes are connected to generate an overall digest of the event. Accordingly, the generated overall digest can be optimal for the genre of the event. The generation of the overall digest of the event is automatic.

### Sixth Embodiment

A sixth embodiment of this invention is similar to the second embodiment thereof except for design changes mentioned hereafter. A digest generating apparatus in the sixth embodiment of this invention includes a GPS receiver. The digest generating apparatus generates attribute information about each moving-image file in response to the output signal of the GPS receiver. The digest generating apparatus gives the generated attribute information to the moving-image file. Specifically, attribute information about each moving-image file represents a shooting place relating to the file.

In the sixth embodiment of this invention, the step S202 (see FIG. 18) refers to attribute information about moving-image files relating to the event, and thereby detects shooting places relating to the moving-image files. The step S202 calculates the total distance traveled from the detected shooting places. The step S202 decides a scene classification threshold value depending on the calculated distance traveled and a prescribed coefficient. For example, the step S202 multiplies the calculated distance traveled by the prescribed coefficient, and sets the scene classification threshold value to the result of the multiplication. In this case, when the calculated distance traveled is 60000 meters and the prescribed coefficient is 1/2000 (minutes/meters), the scene classification threshold value is 30 minutes.

According to the sixth embodiment of this invention, moving-image files are generated from the output signals of the image capturing section 31 and the sound capturing section. Tags are given to the moving-image files, respectively. By referring to the tags, the moving-image files are classified into groups assigned to respective events. The events are grouped according to genre. Two or more different events may be in a same genre. Scene classification threshold values are given for the genres, respectively. The scene classification threshold values are decided depending on the shooting places relating to the moving-image files. In addition, digest generating methods are given for the genres, respectively. Moving-image files relating to each event are classified in response to the scene classification threshold value for the genre of the event into groups assigned to respective scenes. This scene-based classification of the moving-image files can be optimized by the shooting places relating to the moving-image files for the event. For each of the scenes, portions are extracted from related moving-image files in the digest generating method for the genre of the event. The extracted portions are connected to generate data representing a digest of the scene. In this way, digests of the respective scenes are generated. The generated digests of the respective scenes are connected to generate an overall digest of the event. Accordingly, the generated overall digest can be optimal for the genre of the event. The generation of the overall digest of the event is automatic.

### Seventh Embodiment

A seventh embodiment of this invention is similar to one of the first to sixth embodiments thereof except for a design change mentioned hereafter. A digest generating apparatus in the seventh embodiment of this invention is provided in a digital camera, a mobile telephone set having a movie camera, or another system having a movie camera.

### Eighth Embodiment

An eighth embodiment of this invention is similar to one of the first to seventh embodiments thereof except for a design change mentioned hereafter. In the eighth embodiment of this invention, a scene classification threshold value is decided depending on a parameter different from the time length of a related event, the average of the time intervals in shooting between moving-image files relating to the event, and the shooting positions relating the moving-image files. The scene classification threshold value may be decided depending on the combination of at least two of different parameters.

### Ninth Embodiment

A ninth embodiment of this invention is similar to one of the first to eighth embodiments thereof except for a design change mentioned hereafter. According to the ninth embodiment of this invention, the scene-based classification is implemented while an overall digest of each event is not generated.

An overall digest of each event may be generated in a method different from those in the first to eighth embodiments of this invention.

### Tenth Embodiment

A tenth embodiment of this invention is similar to one of the second to ninth embodiments thereof except for design changes mentioned hereafter.

According to the tenth embodiment of this invention, the scene classification threshold value is decided on the basis of the attribute information about the event, and the steps S203-S215 are omitted from the program segment in FIG. 18 so as to remove the limitation on the decided scene classification threshold value through the use of the maximum or the minimum depending genre and also remove the adjustment of the decided scene classification threshold value for the specified genres.

### Eleventh Embodiment

An eleventh embodiment of this invention is similar to one of the second to ninth embodiments thereof except for design changes mentioned hereafter.

According to the eleventh embodiment of this invention, the scene classification threshold value is decided on the basis of the attribute information about the event, and the steps S205-S215 are omitted from the program segment in FIG. 18 so as to remove the limitation on the decided scene classification threshold value through the use of the maximum or the minimum depending genre and implement the adjustment of the decided scene classification threshold value for the specified genres.

What is claimed is:

1. A digest generating apparatus comprising:
first means for generating a tag for each of moving-image files, the tag including genre information and event identification information, the genre information representing a genre of an event relating to the moving-image file, the event identification information identifying the event relating to the moving-image file;
second means for classifying the moving-image files into groups corresponding to respective events in response to the event identification information in the tags;
third means for detecting time intervals in shooting between the moving-image files;
fourth means for classifying moving-image files in each of the event corresponding groups into groups corresponding to respective scenes in response to the time intervals detected by the third means;
fifth means for extracting portions from moving-image files in each of the scene corresponding groups in response to the genre information in the tags; and
sixth means for generating data representative of a digest from the portions extracted by the fifth means.

2. A digest generating apparatus as recited in claim 1, wherein the fourth means comprises:
means for deciding a threshold value concerning the genre of the event in response to the genre information; and
means for classifying the moving-image files in the event corresponding group into the scene corresponding groups in response to the detected time intervals and the decided threshold value.

3. A digest generating apparatus as recited in claim 1, wherein the fourth means comprises:
means for providing a maximum value concerning the genre of the event in response to the genre information;
means for deciding a threshold value concerning the genre of the event in response to attribute information about the moving-image files in the event corresponding group;
means for comparing the provided maximum value and the decided threshold value to generate a comparison result;
means for selecting the provided maximum value as a final threshold value when the comparison result indicates that the decided threshold value is equal to or greater than the provided maximum value;
means for selecting the decided threshold value as a final threshold value when the comparison result indicates that the decided threshold value is smaller than the provided maximum value; and
means for classifying the moving-image files in the event corresponding group into the scene corresponding groups in response to the detected time intervals and the final threshold value.

4. A digest generating apparatus as recited in claim 1, wherein the fourth means comprises:
means for providing a minimum value concerning the genre of the event in response to the genre information;
means for deciding a threshold value concerning the genre of the event in response to attribute information about the moving-image files in the event corresponding group;
means for comparing the provided minimum value and the decided threshold value to generate a comparison result;
means for selecting the provided minimum value as a final threshold value when the comparison result indicates that the decided threshold value is equal to or smaller than the provided minimum value;
means for selecting the decided threshold value as a final threshold value when the comparison result indicates that the decided threshold value is greater than the provided minimum value; and
means for classifying the moving-image files in the event corresponding group into the scene corresponding groups in response to the detected time intervals and the final threshold value.

5. A digest generating apparatus as recited in claim 1, wherein the fourth means comprises:
means for deciding a threshold value concerning the genre of the event in response to attribute information about the moving-image files in the event corresponding group;
means for deciding whether or not the genre of the event is a specified genre;
means for adjusting the decided threshold value in response to a prescribed coefficient and labeling the adjusted threshold value as a final threshold value when it is decided that the genre of the event is the specified genre;
means for labeling the decided threshold value as a final threshold value when it is decided that the genre of the event is not the specified genre; and
means for classifying the moving-image files in the event corresponding group into the scene corresponding groups in response to the detected time intervals and the final threshold value.

6. A digest generating apparatus as recited in claim 3, wherein the fourth means comprises means for calculating a time length of the event from the attribute information, and means for deciding the threshold value concerning the genre of the event in response to the calculated time length.

7. A digest generating apparatus as recited in claim 3, wherein the fourth means comprises means for calculating an average of time intervals in shooting between the moving-image files in the event corresponding group from the attribute information, and means for deciding the threshold value concerning the genre of the event in response to the calculated average.

8. A digest generating apparatus as recited in claim 3, wherein the attribute information represents shooting places relating to the moving-image files in the event corresponding group.

9. A digest generating method comprising the steps of:
classifying moving-image files into groups corresponding to respective events in response to event identification information in tags for the respective moving-image files, wherein each of the tags includes genre information and event identification information, the genre information representing a genre of an event relating to the present moving-image file, the event identification information identifying the event relating to the present moving-image file;
detecting time intervals in shooting between the moving-image files;
classifying moving-image files in each of the event corresponding groups into groups corresponding to respective scenes in response to the detected time intervals;
extracting portions of moving-image files in each of the scene corresponding groups in response to the genre information in the tags; and
generating data representative of a digest from the extracted portions.

10. A digest generating apparatus comprising:
first means for classifying moving-image files into groups corresponding to respective events;
second means for detecting time intervals in shooting between the moving-image files;
third means for classifying moving-image files in each of the event corresponding groups into groups corresponding to respective scenes in response to the time intervals detected by the second means;
fourth means for detecting a genre of each of the events;
fifth means for extracting portions from moving-image files in each of the scene corresponding groups in response to the genre detected by the fourth means; and
sixth means for generating data representative of a digest from the portions extracted by the fifth means.
